(19) United States
(12) Patent Application Publication
(10) Pub. No.: US 2010/0078897 A1
(43) Pub. Date: Apr. 1, 2010

(54) MULTIPLE COMPONENT GASKET

(76) Inventors: David A. McPeek, JR., Gnadenhutten, OH (US); Kenneth R. Bertram, Massillon, OH (US); Forrest Adam Sanders, Marietta, OH (US); Kevin John Edwards, Louisville, OH (US)

Correspondence Address: FRED ZOLLINGER III, P.O. BOX 2368, NORTH CANTON, OH, 44720, US

(21) Appl. No.: 12/508,138

(22) Filed: Jul. 23, 2009

Related U.S. Application Data
(60) Provisional application No. 61/083,227, filed on Jul. 24, 2008.

(51) Int. Cl. F16J 15/02; B32B 37/06

(52) U.S. Cl. 277/637; 156/273.7

(57) ABSTRACT

A multiple component gasket includes at least one mounting body that is fused to at least one sealing body. The sealing body is softer than mounting body. The sealing body may be an EPDM with the mounting body being a polypropylene. The multiple component gasket is made by preheating the sealing body with an infrared heat lamp and then passing the sealing body over heated pressure roller. The mounting body portion is disposed against an opposing chill roller in a manner such that the two portions directly engage each other. Hot air is forced against the location where the two portions engage each other just before the two portions pass between the two rollers. The combination of the heat and the pressure fuses the sealing body to the mounting body. The resulting gasket fails at the tear strength of the sealing body.

### CROSS REFERENCE TO RELATED APPLICATIONS

This application claims the benefit of U.S. provisional patent application Ser. No. 61/083,227 filed Jul. 24, 2008; the disclosures of which are incorporated herein by reference.

### BACKGROUND OF THE INVENTION

1. Technical Field

The present invention generally relates to gaskets and seals. More particularly, the invention relates to a multiple component gasket wherein the gasket includes a softer sealing body connected to a harder mounting body. The invention also relates to a method for joining the softer sealing body to the harder mounting body.

2. Background Information

Many existing gaskets and seals are extruded from a single soft material such as EPDM. One drawback with these gaskets is that the cost of EPDM is higher than plastic materials and EPDM only needs to be used at the sealing locations of the gasket. Another drawback with these soft gaskets is the limited ability to use mechanical connectors through the mounting portion of the gasket. When mechanical connectors such as staples, nails, tacks, screws, or rivets are used through a soft EPDM mounting body on a gasket, there is risk the gasket material will tear at the location of the connector.

In order to avoid mechanical connectors, some gaskets are anchored with an adhesive, such as a pressure sensitive adhesive, secured to the mounting body of the gasket, protected with a release liner until use, and is then secured to a structure that receives the gasket. Other gaskets are mounted by sliding or snap fitting a male mounting body into female mounting channel having a cross section complementary to the male mounting body. The mounting body of the gasket and the female mounting channel cooperate to define an interference fit. A drawback to these systems is the difficulty of loading a long gasket into a female mounting channel. The flexibility of the gasket makes it difficult for a user to fish the mounting body of the gasket through a long mounting channel. The surface finish, the frictional coefficient, or the softness of some gaskets also makes it hard to load the gasket into the channel. In snap fit applications, the opening to the female mounting channel must be small enough to securely hold the mounting body of the gasket. The small opening makes it difficult to the user to quickly load the gasket by forcing the mounting body through the opening of the female mounting channel. Further, the process of forcing the flexible EPDM mounting body of the gasket through the opening of the female mounting channel can damage the mounting body.

### BRIEF SUMMARY OF THE INVENTION

The invention provides a multiple component gasket wherein the sealing body of the gasket is fabricated from a softer material than the mounting body of the gasket. The sealing body is fused to the mounting body to define an integral gasket.

In one configuration of the invention, the sealing body of the gasket is formed from EPDM while the mounting body of the gasket is formed from polyethylene or polypropylene. The EPDM may be a 70 durometer Shore A EPDM or a 2A2 EPDM sponge while the polypropylene may be a 80R (Rockwell scale) material. The mounting body also may be made from polyethylene or a 50 durometer (or higher durometer range) Shore D Santoprene. In another configuration, PVC and nitrile may be joined.

The invention also provides a method for connecting the two portions of the gasket after the two portions are individually fabricated. First, the sealing body and the harder mounting body are formed (such as by extruding) to have their desired individual cross sections. The two portions are later joined together. In one configuration, an EPDM sealing body is preheated with an infrared heat lamp and then disposed against a heated pressure roller. The plastic body portion is disposed against an opposing chill (water cooled) roller in a manner such that the two portions directly engage each other. Hot air is forced against the location where the two portions engage each other just before the two portions pass between the two rollers. The combination of the heat and the pressure fuses the sealing body to the mounting body to form an integral gasket. The resulting gasket will fail at the tear strength of the material of the sealing body.

The invention also provides an apparatus for making the two component gasket. The apparatus includes a heated roller, a chill roller opposing the heated roller, and a source of heat that directs heat between the rolls. One configuration includes a preheater.

The invention provides gasket configurations with mounting bodies and seal bodies wherein the mounting bodies are harder than the seal bodies. In some configurations, the mounting bodies have male cross sections configured to slide into a female cross section mounting channel. Other configurations use a female mounting body that snaps over the top of a male mounting structure. A further configuration uses a flat or angled mounting body that may be secured to a mounting structure with mechanical fasteners. Another configuration uses the mounting body as a wear strip.

The invention also provides multiple element gasket configurations for a slide out wall on a camper or recreational vehicle that replaces a plurality of gaskets.

### BRIEF DESCRIPTION OF THE SEVERAL VIEWS OF THE DRAWINGS

FIG. 1 is a schematic view of the manufacturing process wherein the mounting body is joined to the sealing body.

FIG. 2 is a section view showing an example of a gasket having the mounting body manufactured from a material different from the sealing body.

FIG. 3 is a section view showing an example of a gasket having the mounting body manufactured from a material different from the sealing body.

FIG. 4 is a section view showing an example of a gasket having the mounting body manufactured from a material different from the sealing body.

FIGS. 5 and 6 depict an exemplary continuous gasket that fits on the outside of a mounting structure.

FIGS. 7 and 8 are views of a multi-element, multiple component gasket system having the mounting bodies manufactured from a material different from the seal bodies.

FIGS. 9 and 10 are views of a multi-element, multiple component gasket system having the mounting bodies manufactured from a material different from the seal bodies.

FIG. 11 is a view of an under door gasket using the mounting body as a wear strip.

Similar numbers refer to similar parts throughout the specification.

### DETAILED DESCRIPTION OF THE INVENTION

In the context of this specification, the terms “gasket” and “seal” refer to a structure that joins two systems or elements in such a way as to prevent or minimize leakage between the two systems of elements. Examples of gaskets or seals include those disposed around, under, or along the side of windows and doors. The multiple component gaskets of the invention are generally indicted by the numeral 2 in the accompanying drawings. Each multiple component gasket 2 includes at least one mounting body 4 that is fused to at least one sealing body 6. Sealing body 6 is softer than mounting body 4. Mounting body 4 may be configured as with a male cross section designed to slide within a female mounting channel. Mounting body 4 also may be configured to define a female mounting channel that snaps over a male mounting protrusion. In a further configuration, mounting body 4 may be configured as a wear strip.

In the exemplary configurations of gaskets 2, mounting bodies are polypropylene 80 R (R Scale), polypropylene 60 durometer Shore D, or 50 durometer Shore D Santoprene®. In the exemplary configuration of gaskets 2, seal bodies 6 are 70 durometer Shore A EPDM (ethylene propylene diene Monomer (M-class) rubber), 2A2 EPDM sponge, 50 durometer Shore A ASTM D-2000-00 EPDM, 75 durometer Shore A EPDM, or ASTM D1056-00 sponge. The specific hardnesses are provided for examples of the invention. The invention broadly includes any thermoplastic elastomer (TPE) or thermoplastic (such as PP or PE) base material fused to EPDM dense or sponge. The invention also broadly includes any nitrile connected to PVC.

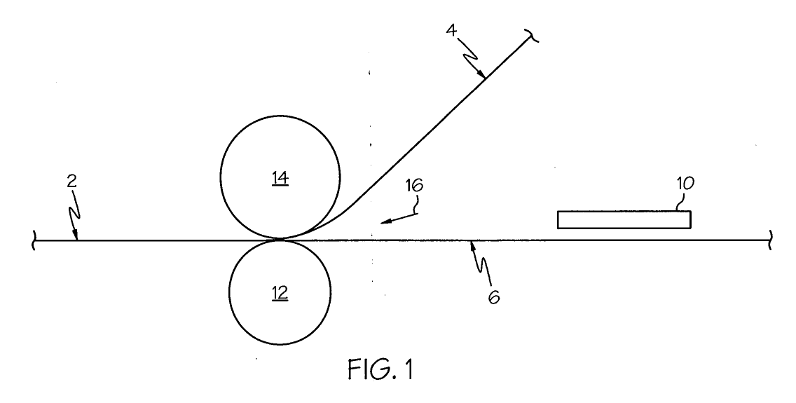

FIG. 1 schematically depicts the apparatus and method for forming gaskets 2. First, sealing body 6 and mounting body 4 are formed to their desired individual cross sectional shapes. Each body 4 and 6 may be extruded and stored for later use. The bodies 4 and 6 are joined together after both have been formed. The timing of the joining may be shortly after complete formation of the individual bodies or after considerable time such as days or weeks. In one configuration, sealing body 6 is preheated with an infrared heat lamp 10 and then disposed against a pressure roller 12. Pressure roller 12 becomes heated from the heated sealing body 6 and hot air 16 that is blown toward roller 12 and does not need to be internally heated. Mounting body 4 is disposed against an opposing chill roller 14 in a manner that causes bodies 4 and 6 to directly engage each other at the location where bodies 4 and 6 are to be joined. Hot air 16 is blown against the location where bodies 4 and 6 engage each other just before bodies 4 and 6 pass between the two rollers 12 and 14 and are pressed together. The pressure may be large enough to crush the profile softer sealing body. The combination of the heat and the pressure allows the plastic of mounting body 4 to partially flow and fuse with the plastic portions of the soft material of sealing body 6 without significantly deforming either cross sectional shape of bodies 4 and 6. The resulting gasket 2 fails at the tear strength of the soft material of sealing body 6. For example, when sealing body 6 is an EPDM material, the heated plastic of mounting body 4 fuses with the EPDM to fuse the two bodies 4 and 6 together.

In an exemplary configuration, the air heater is a 8 kw 240 volt process air heater made by Sylvania. The flow on this unit is 4 cubic feet/min. The infrared unit is 1600 watts and is 36 inches long. The chill roller is a hollowed out cylinder having cold water flowing through. In this example, sealing body 6 is run at 30 ft/min, heat gun temp at 1000 degrees F., chill roller at 50 degrees F., Infrared at (WATTS). The mounting body 4 is a polypropylene that has a thickness of 0.100″. Sealing body 6 is a sponge material having a thickness of thickness 0.300″. The speed for the materials is based on how much heat they can withstand without significantly deforming and this is based on the cross section of the material. The thermoplastic material is heated past its glass transition temperature which allows it to flow. This temperature is different for different thermoplastics and for different suppliers.

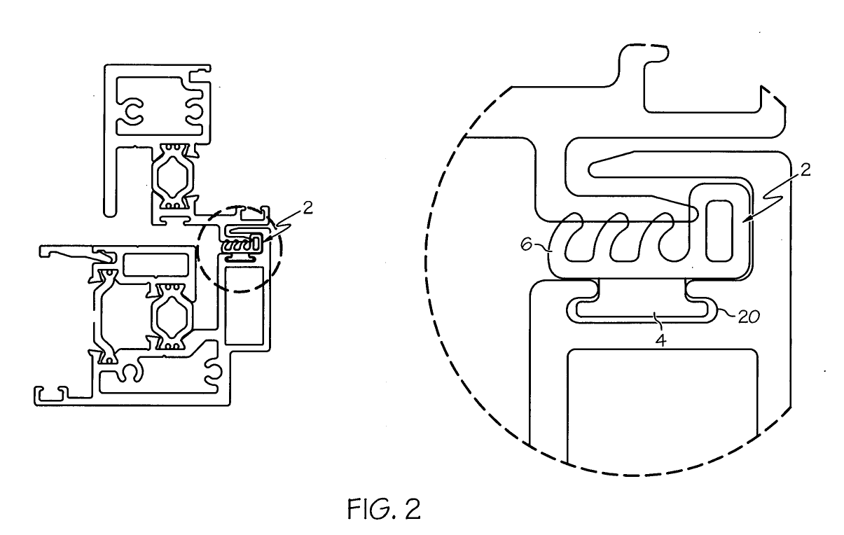

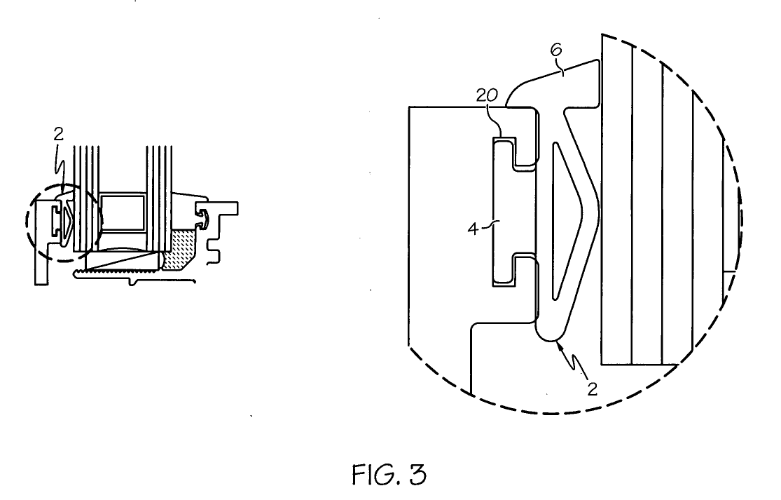

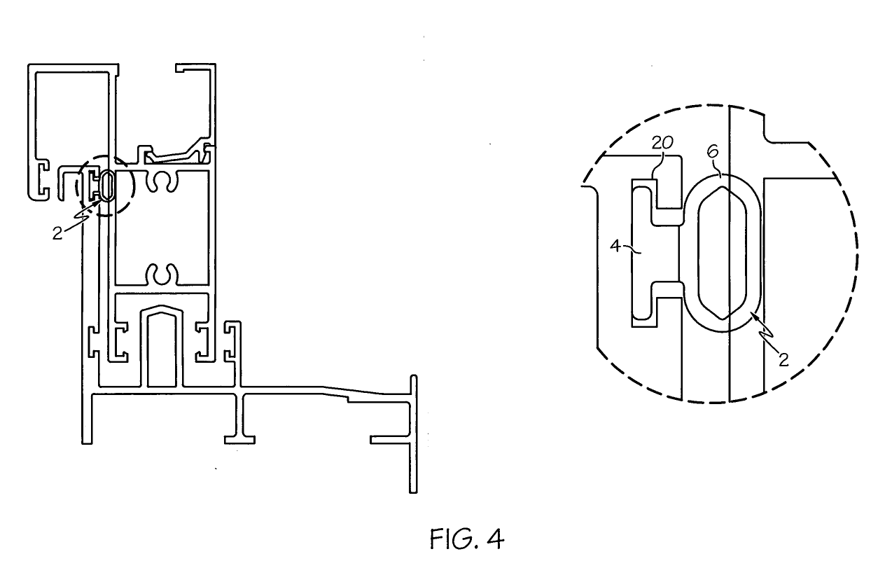

FIGS. 2-4 depict examples of gasket 2 wherein mounting body 4 is designed to slide or be snap fit into a female mounting channel 20. The friction between the polypropylene mounting body 4 and the aluminum mounting channel is less than the friction between a prior art EPDM mounting body and an aluminum mounting channel and the invention thus makes it easier for a person to load these items into a mounting channel. The polypropylene mounting body is also easy to slide into channel 20 because it is fairly rigid.

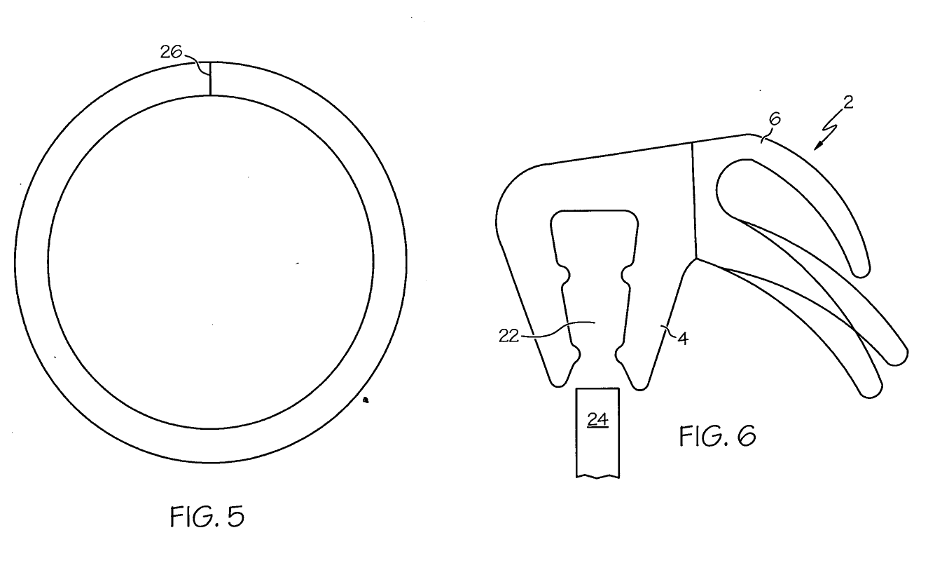

FIGS. 5-6 depict an example of gasket 2 wherein mounting body 4 defines a toothed slot 22 that receives a male mounting protrusion 24 in a snap fit connection. In this example, gasket 2 is designed to be continuous and needs a splice joint 26. The adhesive used to form splice 26 is disposed only on mounting body 4.

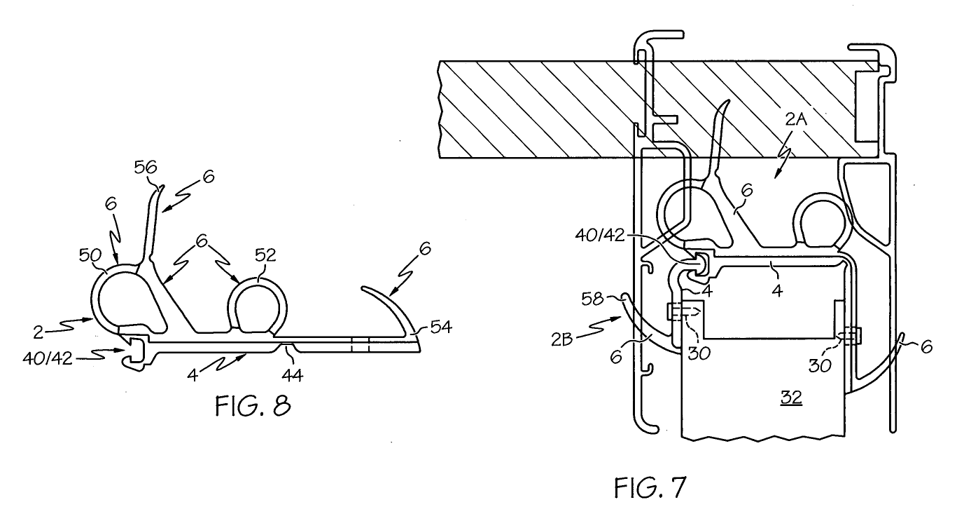

FIGS. 7-10 depict multiple-element, multiple component gaskets 2 that snap together to function as a large single gasket disposed about three sides of a structure 30 such as the end of a sidewall adjacent a slide out wall of a recreational vehicle. The two combined multiple-element gaskets 2 replace the numerous gaskets in the prior art sealing systems. The gaskets 2 of FIGS. 7-10 allow the structure of sidewall 32 to be simplified because gaskets 2 may be secured to sidewall 32 with mechanical connectors 30.

The gasket configurations of FIGS. 7-8 includes a first gasket 2A connected to a second gasket 2B as shown in the drawing. First gasket 2A includes a flat mounting body 4 having a first end that defines a first portion 40 of a snap fit connector that engages a second portion 42 of a snap fit connector defined by the first end of mounting body 4 of second gasket 2B. Portions 40 and 42 of snap fit connectors may be located on either gasket 2A or 2B. Mounting holes for connectors 30 (screws, bolt, rivets) may be formed in flat mounting body 4 before or after body 4 is joined to seal bodies 6. Mounting body 4 of gasket 2A is formed with a living hinge 44 that allows gasket 2A to be bent around the corner of wall 32. Sealing body 6 extends over the entire width of mounting body 4 and includes two beads 50, 52 and two wipers 54, 56. One wiper 56 extends from one bead 50. Gasket 2B includes a single wiper 58 that defines the sealing body 6 of gasket 2B.

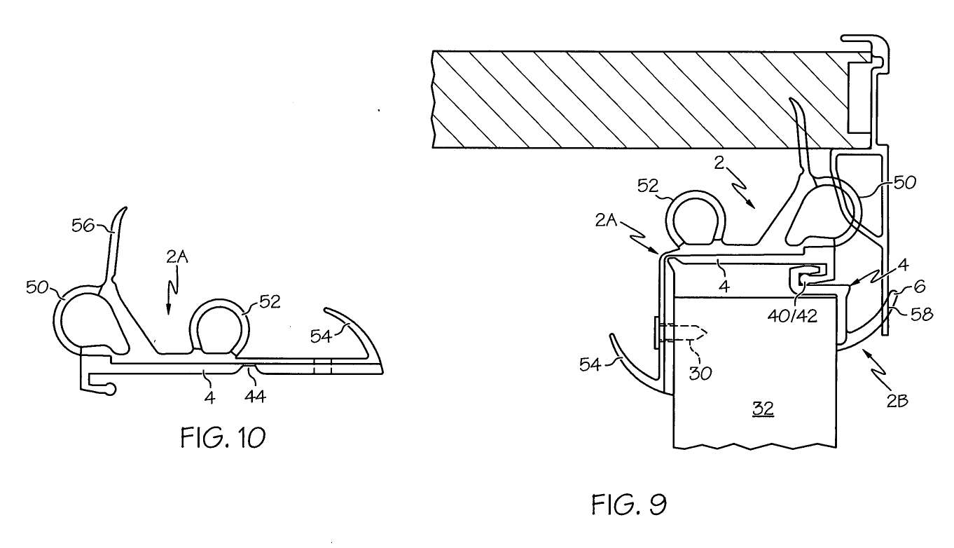

The gasket configuration of FIGS. 9-10 includes a first gasket 2A connected to a second gasket 2B as shown in the drawing. First gasket 2A includes a flat mounting body 4 that folds about a corner and has a first end that defines a first portion 40/42 of a snap fit connector that engages a second portion 40/42 of a snap fit connector defined by the first end of mounting body 4 of second gasket 2B. The two portions of the snap fit connector may be located on either the first or second gasket. In this configuration, both of the connector portions define female locking channels with a male locking member. Further, both connections are removed from the surface of the wall 32 with a portion of the second gasket 2B disposed between the wall 32 and the snap fit connection. Mounting holes for connectors 30 may be formed in the flat mounting body 4 before or after the body is joined to the seal bodies 6. Mounting body 4 of the first gasket 2A is formed with a living hinge 44 of reduced thickness that allows the gasket 2A to be bent around the corner. The sealing body 6 extends over the entire width of the mounting body 4 and includes two hollow beads 50 and 52 and two wipers 54 and 56. One wiper 56 extends from one bead 50. The second gasket 2B includes a single wiper 58 that defines the sealing body 6 of the second gasket 2B.

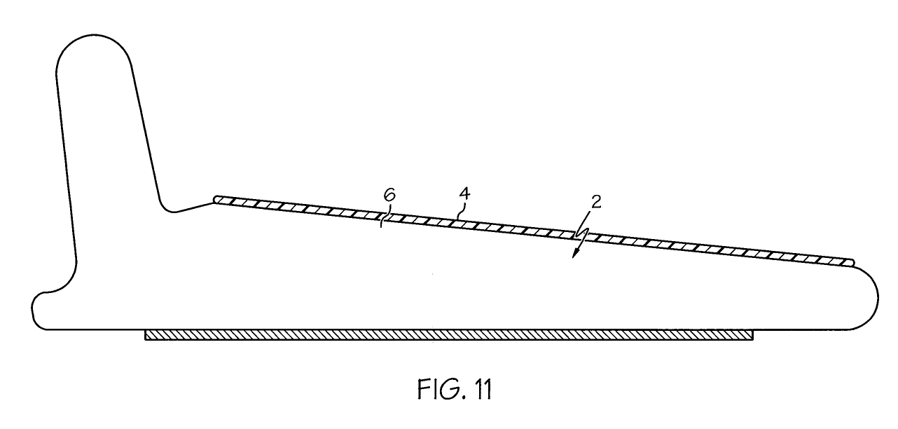

FIG. 11 depicts an exemplary door seal having a sealing body 6 with mounting body 4 used as a wear strip at the location where the door repeatedly slides over gasket 2. An adhesive is disposed on the side of sealing body 6 opposite mounting body 4.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method of forming a multiple component gasket; the method comprising the steps of:
providing a mounting body fabricated from a first material;
providing a sealing body separate from the mounting body; the sealing body being fabricated from a second material that is softer than the first material;
bringing the mounting body into contact with the sealing body between a pressure roll and a chill roll wherein the mounting body is in contact with the chill roll and the sealing body is in contact with the pressure roll; and
heating the connection between the mounting body and the sealing body to fuse the second material to the first material.

2. The method of claim 1, further comprising the step of preheating the sealing body before it contacts the pressure roll.

3. The method of claim 2, wherein the step of preheating the sealing body includes the step of passing the sealing body under an infrared heat lamp.

4. The method of claim 1, wherein the step of heating the connection between the mounting body and the sealing body includes the step of blowing hot air against the connection.

5. The method of claim 1, wherein the step of providing the mounting body includes the step of providing a mounting body fabricated from one of a thermoplastic elastomer, a polypropylene, and a polyethylene.

6. The method of claim 5, wherein the step of providing the sealing body includes the step of providing a sealing body fabricated from EPDM.

7. A gasket for use with a mounting structure; the gasket comprising:
a mounting body having a cross sectional configuration adapted to connect with the mounting structure;
the mounting body being fabricated from a first material;
a sealing body fabricated from a second material; the second material being fused to the first material to join the sealing body to the mounting body; and
the second material being softer than the first material.

8. The gasket of claim 7, wherein the second material is an EPDM.

9. The gasket of claim 8, wherein the first material is one of a polypropylene and a polyethylene.

10. The gasket of claim 7, wherein the mounting body has a male cross sectional configuration.

11. The gasket of claim 7, wherein the mounting body has a female cross sectional configuration.

12. A multiple element gasket comprising:
a first multiple component gasket connected to a second multiple component gasket with a snap fit connector;
each of the multiple component gaskets having a mounting body having a cross sectional configuration adapted to connect with the mounting structure; the mounting body being fabricated from a first material; a sealing body fabricated from a second material; the second material being fused to the first material to join the sealing body to the mounting body; and the second material being softer than the first material; and
the snap fit connector being defined by the mounting bodies of the first and second multiple component gaskets.

13. The gasket of claim 12, wherein one of the multiple component gaskets includes a pair of beads and a pair of wipers.

14. The gasket of claim 13, wherein one of the wipers extends from one of the beads.

15. The gasket of claim 12, wherein the mounting body of one of the multiple component gaskets defines a living hinge that allows the multiple component gasket to be bent around a corner.
